(19) United States
(12) Patent Application Publication
(10) Pub. No.: US 2010/0009210 A1
(43) Pub. Date: Jan. 14, 2010

(54) PROCESS FOR COATING A SUBSTRATE WITH A COATING

(76) Inventors: Kevin Jeffrey Kitte, Durham (GB); Nigel Ivor Edward Shewring, Franklin (GB)

Correspondence Address: KENYON & KENYON LLP, ONE BROADWAY, NEW YORK, NY, 10004, US

(21) Appl. No.: 12/514,187

(22) PCT Filed: Nov. 7, 2007
(86) PCT No.: PCT/EP2007/061987

§ 371 Date: May 8, 2009

Related U.S. Application Data
(60) Provisional application No. 60/873,679, filed on Dec. 7, 2006.

(51) Int. Cl. B32B 27/32; B05D 3/00; B05D 3/06; B05D 3/02

(52) U.S. Cl. 428/523; 427/521; 264/447; 427/487

(57) ABSTRACT

The present invention pertains to a process for coating a substrate comprising the steps of providing a substrate the outer layer of which comprises an electroheat-susceptible material of applying a powder coating composition onto the substrate curing the powder coating composition using electroheat radiation. The electroheat-susceptible material may be a microwave-susceptible material with the curing being effected using microwave radiation. It may also be a radio frequency-susceptible material, in which case the curing is effected using radio frequency radiation. The substrate may be provided with an outer layer which comprises an electroheat-susceptible material by contacting the substrate with a primer comprising an electroheat-susceptible material or by coating the inside of a mould with a primer layer, filling the mould with a curable resin that will form the substrate, curing the resin, and releasing the substrate the outer layer of which comprises an electroheat-susceptible material from the mould. The process is particular suitable for coating heat-sensitive substrates, where it will allow electroheat curing of conventional powder coating compositions.

The present invention pertains to a process for coating a substrate with a powder coating. It also pertains to substrates obtainable by this process.

Powder coating compositions are a growing segment of the coating market. As the name says, a powder coating composition is a coating composition in the form of a powder. Thermosetting powder coating compositions comprise a resin and a curing agent. They are applied onto the substrate, e.g., via an electrostatic process wherein a charge difference is generated between the particles and the substrate, causing the particles to adhere to the substrate. Superfluous coating can easily be recovered, making for an economical process. As no solvents are present, it also makes for an environmentally friendly process. The substrate provided with the coating is subjected to a heating step to fuse the particles together to form a coating, and to a curing step in which the resin and the curing agent react to form a crosslinked polymer network. A thermoset powder that has been cured and crosslinked will not melt and flow again if subjected to heat a second time.

Various ways to cure powder coating compositions are known in the art. In the most common curing process the coating layer is cured on the substrate by the application of heat (the process of stoving). The curing times and temperatures are interdependent in accordance with the composition formulation that is used, and will vary between 10 seconds at a temperature of the order of 280° C. to 40 minutes at a temperature of the order of 100° C. The disadvantage of this curing process is that for an efficient curing process high temperatures should be used, while not all substrates can withstand such high temperatures. Additionally, in the conventional process the coated substrate is led through an oven, which means that not only the coating layer, but also the substrate and the air surrounding it are heated and subsequently cooled. Even if this does not affect the substrate, unnecessary heating and cooling of substrate and air is an inefficient use of energy.

The use of radiant energy such as infra-red or UV in the curing of powder coatings is also known.

UV curing of powder coatings requires the presence of a photoinitiator, the properties of which should be carefully matched to those of the resin, the curing agent, and the other components of the powder coating composition, such as the pigment. As compared to stoving, curing powder coatings with UV light can cut the cure time significantly. However, UV powder formulations other than clear and translucent coatings can be difficult to cure all the way down through to the substrate.

IR curing of powder coatings may be attractive, because less energy is wasted in heating the substrate or the air surrounding it. Further, the coating layer is heated from the outside going in, which means that temperature-sensitive substrates are exposed to less heat than in conventional curing using an oven. However, especially when curing coatings on temperature-sensitive substrates, it is difficult to control the process in such a manner that the coating layer is heated sufficiently to effect full curing while at the same time not affecting the substrate. In addition, in conventional IR curing, IR waves with a variety of wavelengths are used, where some will heat the powder coating to effect flowing and curing, but others will be absorbed by the substrate and heat that, or will be absorbed by the air, making for an inefficient use of energy.

Curing resins using microwave irradiation is also known in the art.

DE 3511654 describes a resin containing microwave susceptors which is cured using microwaves, the susceptors being heated by catching the waves and initiating the curing reaction.

U.S. Pat. No. 5,234,760 describes coating a heat-sensitive substrate with a powder coating followed by film-formation of the coating through electromagnetic radiation. The substrate should be at most very slightly excitable by microwaves. The coating is based on a microwave-excitable polymer.

In both references, the powder coating has to be specifically adapted to be suitable for microwave curing. In U.S. Pat. No. 5,234,760 the coating has to be based on a specific type of polymer, which will lead to increased costs. In DE 3511654 an electroheat-susceptible material is to be added to a conventional polymer resin. This will necessitate reformulation and testing of the resin composition to ensure that its properties are not affected.

However, microwave curing of powder coatings is still attractive for a number of reasons. The application of microwaves results in very fast, virtually instantaneous heating of the powder coating, as a result of which melting and curing conditions are obtained very quickly. The process can be carried out in a controlled manner, where undesired heating of the substrate is prevented. Additionally, while most substances absorb IR waves in greater or lesser amounts, fewer substances are microwave absorbers. Therefore, the energy put into the process will be used more efficiently, because there is less absorbance which does not contribute to the flowing and curing of the powder coating.

Accordingly, there is need for a process for curing a powder coating composition using microwaves, or in a broader aspect, electroheating, which is flexible and can be used with any conventional type of heat-curable powder coating composition. The present invention provides such a process.

The present invention pertains to a process for coating a substrate comprising the steps of
providing a substrate the outer layer of which comprises an electroheat-susceptible material
applying a powder coating composition onto the substrate
curing the powder coating composition using electroheating.

It is noted that it is known in the art to provide a non-conductive substrate with a conductive material to make it possible to apply a powder coating composition via an electrostatic process.

Reference is made to U.S. Pat. No. 6,296,939, which describes a process for applying a powder coating composition to a heat-sensitive substrate like wood by the steps of heating a substrate by microwave radiation, applying a powder coating composition, and heating and curing the paint. For particularly sensitive substrates it is preferred to first coat the substrate with an electrically conductive water-based paint, which may be dried via microwave radiation. The possibility of using irradiation-curable coatings such as coatings curable via UV radiation or electron radiation is mentioned, but it is expressly mentioned that electromagnetic radiation is not suitable for curing the powder paint.

U.S. Pat. No. 4,587,160 describes the provision of a graphite-containing outer layer on a thermosetting polymer to obtain a value for the surface conductivity which allows electrostatic spray painting. However, this reference seems to be directed to electrostatic spray painting of liquid paints. The use of graphite as electroheat-susceptible material to allow microwave curing of powder coatings is not envisaged in this document.

Within the context of the present specification the term electroheating refers to heating using radiation with a frequency of 10 MHz to 3 GHz. Radiation with a frequency of 10 MHz to 100 MHz will be indicated as radio frequency, or RF, radiation, while radiation with a frequency of 100 MHz to 3 GHz will be indicated as microwave radiation. In commercial practice specific wavelengths have been allocated for the purposes of heating. For the United States, the allocated radio frequencies are 13.56 MHz±6.68 kHz, 27.12 MHz±160.00 kHz, and 40.68 MHz±20.00 kHz. The allocated microwave frequencies are 915 MHz±13 MHz, 2450 MHz±50 MHz, 5800 MHz±75 MHz, and 24125 MHz±125 MHz. In other countries or regions, different frequencies may have been allocated for heating; in particular, outside of the United States frequencies of 433.92 MHz, 896 MHz, and 2375 MHz have been allocated. In a preferred embodiment of the present invention, the process is carried out using radiation with a frequency allocated for heating in the country where the process is carried out.

Heating with microwave and radio frequencies involves two mechanisms, namely ionic conduction and dielectric heating. Ionic conduction primarily takes place in the RF range. In this mechanism, the application of an electromagnetic field leads to oscillation of ions with the oscillation of the field. If there is any electrical resistance in the conductor, then this ionic movement will generate heat. In the microwave range there is the combined use of ionic conduction and dielectric heating, with dielectric heating being the main mechanism. In dielectric heating, molecules with a dipolar or magnetic nature will oscillate with the oscillation of the electromagnetic field, resulting in heating.

The process according to the invention starts out from a substrate the outer layer of which comprises an electroheat-susceptible material.

An electroheat-susceptible material is defined as a material which absorbs radiation with a frequency in the electroheating range and converts it to heat. They are generally solid particulate materials which are dispersed in the primer, the particles being conductive and/or magnetic. Suitable conductive materials include carbon black, graphites, metals, such as aluminium, conductive oxides like indium tin oxide, fluorine-doped tin oxides, etc. Suitable magnetic materials include ferrites. Mixtures of various materials may also be used, e.g., a mixture of a conductive and a magnetic material.

In one embodiment the electroheat-susceptible material is primarily susceptible to microwave radiation. This will further be indicated as a microwave-susceptible material. In another embodiment the electroheat-susceptible material is primarily susceptible to radio frequency radiation. This will further be indicated as an RF-susceptible material.

In general, conductive materials, including those listed above, are microwave-susceptible materials, while magnetic materials, including those listed above, are RF-susceptible materials.

A substrate the outer layer of which comprises an electroheat-susceptible material can be obtained by contacting the substrate with a primer comprising an electroheat-susceptible material. This contacting can be carried out in various ways.

In one embodiment of the present invention, a substrate is coated with a primer comprising an electroheat-susceptible material. In this embodiment the primer can be liquid or solid (determined at application temperature). Liquid primers can be applied in any manner known in the art for the application of liquid coating materials, e.g., using brushes, sprays, rollers, dip coating, curtain coating, etc. Solid primers are in particulate form. They may be applied to the substrate via a powder spraying process. If the substrate so allows, an electrostatic application process, whether in the form of an electrostatic fluidised bed or in the form of an electrostatic spraying process, may be used. For electrostatic bed applications, also for non-conductive substrates and less-conductive substrates, reference is made to WO 99/30838, WO02/098577, WO 2004/052558, and WO 2004/052557.

In another embodiment of the present invention the contacting of the substrate with the primer is carried out during the moulding process of the substrate. More in particular, in this embodiment the contacting with a primer is performed by coating the inside of a mould with a layer of a primer, filling the mould with a curable resin that will form the substrate, curing the resin, and releasing the substrate the outer layer of which comprises an electroheat-susceptible material from the mould. Also in this embodiment the primer may be solid or liquid, with solid primers being preferred.

It is preferred for the primer to contain a resin in addition to the electroheat-susceptible material.

The presence of a resin increases the adhesion of the electroheat-susceptible material to the substrate. It can also increase the adhesion of the powder coating composition to the substrate. An additional advantage of the presence of a resin in the primer is that it can act as a heat dispersant. It will help the distribution of heat through the entire coating layer, resulting in less risk of the formation of hot spots.

The presence of a curable resin will also help to fix the electroheat-susceptible material to the material coated therewith, be it the substrate or the mould.

In one embodiment of the process according to the invention, a substrate the outer layer of which comprises an electroheat-susceptible material is provided by coating a substrate with a primer comprising a curable resin and an electroheat-susceptible material, and curing the primer partially or fully to help fix the electroheat-susceptible material to the substrate.

In another embodiment of the process according to the invention, a substrate the outer layer of which comprises an electroheat-susceptible material is provided by coating the inside of a mould with a layer of primer, curing the primer partially or fully to help fix the electroheat-susceptible material to the mould, filling the mould with a curable resin that will form the substrate, curing the resin, and releasing the substrate the outer layer of which comprises an electroheat-susceptible material from the mould.

The electroheat-susceptible material is generally present in the primer in an amount of 100 to 2 wt. %, calculated on the total of electroheat-susceptible material and resin present in the primer. If the resin is added to obtain one or more of the advantageous effects described above, it is preferably added in an amount of at least 10% of the total of electroheat-susceptible material and resin, more preferably at least 20%. The addition of very little electroheat-susceptible material may result in insufficient curing efficiency of the powder coating composition to be cured. Accordingly, it may be preferred for the electroheat-susceptible material to make up at least 10% by weight of the total of resin and electroheat-susceptible material.

If the primer is a solid primer, the resin used therein will be a solid resin. The primer may comprise resin particles mixed with particles of an electroheat-susceptible material, but it is also possible for the primer to comprise particles containing both resin and electroheat-susceptible material. Accordingly, the primer may be obtained by mixing particles of a resin with particles of an electroheat-susceptible material, by mixing particles of a resin with particles of an electroheat-susceptible material followed by a step to bond the particles of the electroheat-susceptible material to the resin particles, or by mixing the electroheat-susceptible material with the resin in liquid form and then converting the mixture into particles, e.g. by solidifying the mixture and grinding.

If the solid primer is to be applied by coating the substrate, suitable resins include the resins for powder coating compositions described hereafter in the present specification. In one embodiment, the coating primer comprises a conventional powder coating composition to which an electroheat-susceptible material has been added, for example by dry-blending it with the existing powder coating composition, by bonding it to the existing powder coating composition, or by adding it to the powder coating composition at some stage during its manufacture, which results in the incorporation of the electroheat-susceptible material into the particles of the powder coating composition. For example, the electroheat-susceptible material can be added to the powder coating before extrusion. These powder coating compositions are the same as those for application on the primer described hereafter in this specification.

If the primer is to be applied to the mould, the nature of the resin can be selected to be compatible with the resin that will become the substrate.

If the solid primer is to be applied to the mould, it generally has a particle size of 1-300 microns, preferably 10-200 microns. Preferably, 95% by volume is below 120 microns. In some embodiments it may be attractive for 95% of the particles to be below 50 microns, or even below 20 microns. When a large percentage of small particles is present, it may be attractive to include a dry-flow improvement additive in the primer. These compounds are known in the art of powder coatings manufacture.

If the solid primer is to be applied to a substrate, it will generally have a particle size of 1-200 microns; preferably at least 95% by volume of the particles have a diameter of at most 120 microns. Again, in some embodiments it may be attractive for 95% of the particles to be below 50 microns, or even below 20 microns. Again, when a large percentage of small particles is present, it may be attractive to include a dry-flow improvement additive in the primer.

If the primer is liquid, it generally contains a liquid carrier, which may be water-based or solvent based. The use of water-based carriers is preferred for environmental reasons.

The resin that may be used in a liquid primer may be in the form of dispersed particles. Solute resins may also be used. In one embodiment the resin is a resin selected from the resins suitable for use in powder coatings. In an aqueous primer this would result in a resin dispersion. Liquid primer layers are dried in a conventional manner. For example, they may be dried at room temperature, at increased temperature using hot air, subjected to microwave irradiation, or using IR. IR may be preferred for the reasons given above.

It is well within the scope of the skilled person to formulate appropriate liquid primers, e.g., by adding electroheat-susceptible particles to conventional liquid primer formulations.

The amount of electroheat-susceptible material available on the surface of the substrate should be an effective amount to allow electroheat curing of the powder coating composition. Determination of the effective amount is well within the scope of the skilled person using conventional trial and error in accordance with the following guidelines. The use of larger amounts of electroheat-susceptible material will lead to increased curing speed, but too much electroheat-susceptible material will take curing out of control, possibly resulting in damage to heat-sensitive substrates. The addition of a conductive electroheat-susceptible material can also serve to increase the surface conductivity of the substrate, which in turn results in an improved addition of powder coating via an electrostatic process, thus resulting in a more even and consistent powder coating layer. It also guards against the build-up of charge on the substrate, leading to smoother coatings.

The amount of electroheat-susceptible material present on the substrate generally is between 0.5 gram/m² and 100 gram/m², preferably between 1 gram/m² and 10 gram/m².

For resin-containing primers, the thickness of the primer layer (after drying/curing) generally is between 10 and 200 microns. When the primer is applied by coating the substrate, the thickness generally is between 10 and 100 microns, preferably between 15 and 80 microns. When the primer is applied to the mould, the thickness generally is between 20 and 300 microns, preferably between 50 and 200 microns. The primer can be applied in one or more layers. For primers which do not contain a resin the primer layer (after curing/drying) may be thinner, e.g., in the range of 1-50 microns, more in particular 1-10 microns.

The particle size of the electroheat-susceptible material should be adapted to the desired thickness of the primer layer. If the primer layer is relatively thick, e.g., for mould curing, an electroheat-susceptible material with a larger particle size may be used. If the primer layer is thinner, the size of the electroheat-susceptible material should be reduced correspondingly. If the particle size of the electroheat-susceptible material is too large, the finished properties of the coating will be undesirable.

The particles of the electroheat-susceptible material generally have a d(v,90) of 30 microns or less, preferably 10 microns or less. The d(v,90) generally is at least 0.5 microns.

As will be evident to the skilled person, the d(v,x) indicates for a stated particle size (d) the percentage (x) of the total volume of particles lying below the stated particle size; the percentage (100-x) of the total area lies at or above the stated size. Thus, for instance, d(v,90)=7 microns indicates that 90% of the particles (the percentage calculated on the particle volume) are below 7 microns and 10% are above this size. Particle sizes are measurable by laser diffraction techniques, for example by the Malvern Mastersizer, and unless indicated otherwise, the sizes quoted are as measured by the Mastersizer 2000, refractive index 1.45, absorption index 0.01.

The primer can contain other components conventional in the art of coatings manufacture, such as stabilisers, thickeners, dispersing aids, wetting agents, adhesion promoters, etc.

The primer may or may not contain pigments. In most cases the powder coating composition to be applied later will contain pigments, and the incorporation of pigment into the primer is not required. However, in some cases, the addition of pigment to the primer may be attractive, especially in systems where the electroheat-susceptible material does not possess a strong colour.

In one embodiment of the present invention the electroheat-susceptible material is embedded in the substrate. This provides increased adhesion of the powder coating layer to the substrate.

Embedding the electroheat-susceptible material in the substrate surface can be achieved in various ways. A first method is by incorporating the electroheat-susceptible material into the surface of a plastic substrate during the moulding process of the substrate, via the method described above.

A further method is by coating a substrate having a heat-deformable outer layer with a primer comprising an electroheat-susceptible material, and then heating the primer layer. This will result in the particles of the electroheat-susceptible material becoming embedded in the substrate. In this embodiment it is attractive for the primer to contain a heat-curable resin in an amount of 10-90% by weight, calculated on the total of resin and primer. The heat-curable resin will cure during the heating performed to embed the electroheat-susceptible material in the substrate and will contribute to fixing the electroheat-susceptible material in the substrate. In the context of the present specification a material is considered embedded in another material if at least 50% by number of the particles meet the requirement that at least 25% of their largest cross-sectional diameter in the direction perpendicular to the substrate surface is embedded in the substrate. Suitable plastic substrates will be evident to the skilled person. In one embodiment, plastic substrates are used which are suitable for interior and exterior applications in the automotive industry, such as airbag covers, bumpers, fascias, fenders, wing mirrors, door panels, panel hoods, panel roofs, and panel trunk lids.

Another embodiment of the present invention is the coating of medium-density fibre-board (MDF). The surface of MDF boards is smooth and has a low porosity. When they are provided with a powder coating, a smooth surface will thus easily be obtained. However, the edges of MDF are relatively porous and rough. Conventional application of a powder coating to the edges will result in adsorption of the molten powder coating resin into the pores, which will result in an irregular coating on the surface of the edges. This effect is aggravated by the rough fibres on the MDF edges, which tend to rise in the direction perpendicular to the edge. When in the process of the present invention an MDF substrate is treated with a primer comprising an electroheat-susceptible material and 30-90% of a resin, calculated on the total of electroheat-susceptible material and resin, the resin will block the pores of the MDF edges so that the resin of the subsequently provided powder coating composition will not sink into the pores. Additionally, any protruding fibres formed during application of the primer can be sanded off after drying the primer, resulting in a smooth, non-porous surface which is very suitable for the application of powder coatings.

A powder coating composition is applied to the substrate the outer layer of which comprises an electroheat-susceptible material. Methods for applying powder coating compositions to substrates are well known in the art.

In one embodiment the powder coating composition is applied to the substrate via an electrostatic process. Any of the electrostatic application processes known in the art of powder coating technology may be used, for example, electrostatic spray coating (corona-charging or tribo-charging) or electrostatic fluidised-bed processes (corona-charging or tribo-charging). These are all part of the common general knowledge of the person skilled in the art and require no further description. The powder coating composition is usually applied in film thicknesses of 5-200 microns, preferably 10-100 microns, more preferably 15-80 microns.

In another embodiment the powder coating composition is applied to the substrate via a heated fluidised bed. In such a process the substrate workpiece is preheated (typically to 200° C.-400° C.) and dipped into a fluidised bed of the powder coating composition. The powder particles that come into contact with the preheated surface melt and adhere to the workpiece. In the case of thermosetting powder coating compositions, the initially coated workpiece may be subjected to further heating to complete the curing of the applied coating. Such post-heating may not be necessary in the case of thermoplastic powder coating compositions.

Generally, powder coatings are in the form of a powder, hence the name. However, in recent years, powder coating slurries have been developed. Powder coating slurries comprise solid resin-containing particles in a liquid medium. Where powder coating slurries are used in the present invention, they can be applied by methods which are conventional for the application of liquid paints, e.g., using brushes, sprays, rollers, dip coating, curtain coating, etc. Powder coating slurries and their manufacture are well known in the art. For further information on these materials reference is made to EP1559751 and US 2003/092799.

After the powder coating composition has been applied, the coated substrate is subjected to electroheat radiation to cure the powder coating composition. As indicated earlier, within the context of the present specification the term electroheating refers to heating using radiation with a frequency of 10 MHz to 3 GHz. Radiation with a frequency of 10 MHz to 100 MHz will be indicated as radio frequency, or RF, radiation, while radiation with a frequency of 100 MHz to 3 GHz will be indicated as microwave radiation. In commercial practice specific wavelengths have been allocated for the purposes of heating. For the United States, the allocated radio frequencies are 13.56 MHz±6.68 kHz, 27.12 MHz±160.00 kHz, and 40.68 MHz±20.00 kHz. The allocated microwave frequencies are 915 MHz±13 MHz, 2450 MHz±50 MHz, 5800 MHz±75 MHz, and 24125 MHz±125 MHz. In other countries or regions, different frequencies may have been allocated for heating; in particular, outside of the United States frequencies of 433.92 MHz, 896 MHz, and 2375 MHz have been allocated. In a preferred embodiment of the present invention, the process is carried out using radiation with a frequency allocated for heating in the country where the process is carried out.

The curing time will generally be between 0.5 seconds and 40 minutes, in particular between 10 seconds and 30 minutes. The energy added will generally be between 10 W and 4 kW. As the skilled person will understand, there is a relationship between the energy supplied and the time required to effect curing, with lower energy levels requiring longer curing times. The energy levels may be varied during the curing process. For example, in one embodiment the curing is started with a high energy pulse to ensure flow of the coating, followed by a number of lower energy pulses to keep the coating molten for as long as is necessary to ensure curing.

As will be evident to the skilled person, the selected frequency will be matched with the nature of the electroheat-susceptible material. If the electroheat-susceptible material is primarily susceptible to RF radiation, curing will be carried out with RF radiation at an RF frequency. Alternatively, if the electroheat-susceptible material is primarily susceptible to microwave radiation, curing will be carried out using microwave radiation at a microwave frequency. If the electroheat-susceptible material is susceptible to both RF and microwave radiation, frequencies in either range may be used.

The process of the present invention may be used on conductive, poorly conductive, and non-conductive substrates. For the purpose of the present specification a non-conductive substrate is defined as a substrate with a surface resistance of more than 10̂11 ohms/square, a poorly conductive substrate is a substrate with a surface resistance of 10̂3 ohms/square to 10̂11 ohms/square, and a conductive substrate is a substrate with a surface resistance of less than 10̂3 ohms/square. The surface resistance is determined in accordance with ASTM-D257-93 with 2K kV applied.

For conductive substrates it will be necessary to use an electroheat-susceptible material which is primarily susceptible to RF radiation, such as ferrite. This also goes for substrates which are in themselves poorly conductive or non-conductive, but which contain conductive parts.

The process according to the invention is particularly suitable for the coating of non-conductive and poorly conductive substrates (the conductivity being determined in the absence of the electroheat-susceptible material).

Suitable non-conductive substrates and poorly conductive substrates include medium density fibre-board (MDF), wood, wood products, plastics materials, plastics materials including electrically conductive additives, polyamide, and highly insulating plastics materials, for example, polycarbonate.

An MDF substrate may have a surface resistance of the order of between 10̂3 ohms/square and 10̂11 ohms/square depending on its moisture content, where a higher moisture content will lead to a lower surface resistance.

Wood and wood products may be expected to have a surface resistance of the order of between 10̂3 ohms/square and 10̂11 ohms/square depending on the type of wood and its moisture content.

Plastics materials including electrically conductive additives and various plastics materials without electrically conductive additives may have a surface resistance of the order of between 10̂3 and 10̂11 ohms/square, depending on the material and, where included, the additive or additives.

Highly insulating plastics materials including, for example, polyamide and polycarbonate, may be expected to have a surface resistance of the order of above 10̂11 ohms/square.

If so desired, the substrate provided with the electroheat-susceptible material is chemically or mechanically cleaned using methods known to the skilled person prior to application of the powder coating. If the electroheat-susceptible material is applied to the substrate using a primer, it may be advantageous to perform a chemical or physical cleaning step before application of the primer.

For example, depending on the nature of the substrate, it may be washed or sanded before use. Other types of pre-treatment known in the art of powder coating application may also be applied. For example, if the substrate contains moisture, like MDF or wood, it may be desired to preheat the substrate to reduce the moisture content before applying the powder coating composition, as the presence of moisture may cause problems during curing of the powder coating composition. In the case of moisture-containing substrates it may be attractive to use RF-curing, because while moisture is sensitive to microwave radiation, causing heating of the substrate, RF radiation is less specific. On the other hand, when properly carried out it is very well possible to apply microwave curing in accordance with the process of the invention on moisture-containing substrates.

One of the advantages of the process according to the invention is that, compared to conventional heat curing, only a very specific area of the substrate is heated, namely the electroheat-susceptible material. The heat generated in the electroheat-susceptible material ensures the curing of the powder coating composition, while the main body of the substrate remains at a lower temperature. Accordingly, in a specific embodiment of the process according to the invention, the substrate is a heat-sensitive substrate. In the context of the present specification a heat-sensitive substrate is a substrate which cannot withstand the conditions prevailing during heat curing of a powder coating composition.

A further advantage of the process according to the invention is that as the electroheat-susceptible material is not incorporated into the powder coating composition, the process can be used with all conventional heat-curable powder coating compositions. Heat-curable powder coating compositions are well-known in the art.

Suitable powder coating compositions comprise one or more film-forming resins and a curing agent therefor. The resin acts as a binder, having the capability of wetting pigments and providing cohesive strength between pigment particles and of wetting or binding to the substrate, and after application to the substrate melts and flows in the curing process to form a homogeneous film.

The film-forming resin may be one or more selected from carboxy-functional polyester resins, hydroxy-functional polyester resins, epoxy resins, and functional acrylic resins.

For example, a carboxy-functional polyester film-forming resin can be used in combination with a polyepoxide curing agent. Such carboxy-functional polyester systems are currently the most widely used powder coatings materials. The polyester generally has an acid value in the range of 10-100, a number average molecular weight Mn of 1,500 to 10,000 and a glass transition temperature Tg of from 30° C. to 85° C., preferably at least 40° C. The poly-epoxide can, for example, be a low molecular weight epoxy compound such as triglycidyl isocyanurate (TGIC), a compound such as diglycidyl terephthalate condensed glycidyl ether of bisphenol A or a light-stable epoxy resin. Such a carboxy-functional polyester film-forming resin can alternatively be used with a bis(beta-hydroxyalkylamide) curing agent such as tetrakis(2-hydroxyethyl)adipamide.

Alternatively, a hydroxy-functional polyester can be used with a blocked isocyanate-functional curing agent or an amine-formaldehyde condensate such as, for example, a melamine resin, a urea-formaldehyde resin, or a glycol ural formaldehyde resin, for example the material “Powderlink 1174” supplied by the Cyanamid Company, or hexahydroxymethyl melamine. A blocked isocyanate curing agent for a hydroxy-functional polyester may, for example, be internally blocked, such as the uretdione type, or may be of the caprolactam-blocked type, for example isophorone diisocyanate.

As a further possibility, an epoxy resin can be used with an amine-functional curing agent such as, for example, dicyandiamide. Instead of an amine-functional curing agent for an epoxy resin, a phenolic material may be used, preferably a material formed by reaction of epichlorohydrin with an excess of bisphenol A (that is to say, a polyphenol made by adducting bisphenol A and an epoxy resin). A functional acrylic resin, for example a carboxy-, hydroxy- or epoxy-functional resin can be used with an appropriate curing agent.

Mixtures of film-forming polymers can be used, for example a carboxy-functional polyester can be used with a carboxy-functional acrylic resin and a curing agent such as a bis(beta-hydroxyalkylamide) which serves to cure both polymers. Further, for mixed binder systems a carboxy-, hydroxy- or epoxy-functional acrylic resin may be used with an epoxy resin or a polyester resin (carboxy- or hydroxy-functional). Such resin combinations may be selected so as to be co-curing, for example a carboxy-functional acrylic resin co-cured with an epoxy resin, or a carboxy-functional polyester co-cured with a glycidyl-functional acrylic resin. More usually, however, such mixed binder systems are formulated so as to be cured with a single curing agent (for example, use of a blocked isocyanate to cure a hydroxy-functional acrylic resin and a hydroxy-functional polyester). Another preferred formulation involves the use of a different curing agent for each binder of a mixture of two polymeric binders (for example, an amine-cured epoxy resin used in conjunction with a blocked isocyanate-cured hydroxy-functional acrylic resin).

Other film-forming polymers which may be mentioned include functional fluoropolymers, functional fluorochloropolymers, and functional fluoroacrylic polymers, each of which may be hydroxy-functional or carboxy-functional and may be used as the sole film-forming polymer or in conjunction with one or more functional acrylic, polyester and/or epoxy resins, with appropriate curing agents for the functional polymers.

Other curing agents which may be mentioned include epoxy phenol novolacs and epoxy cresol novolacs; isocyanate curing agents blocked with oximes, such as isopherone diisocyanate blocked with methyl ethyl ketoxime, tetramethylene xylene diisocyanate blocked with acetone oxime, and Desmodur W (dicyclohexylmethane diisocyanate curing agent) blocked with methyl ethyl ketoxime; light-stable epoxy resins such as “Santolink LSE 120” supplied by Monsanto; and alicyclic poly-epoxides such as “EHPE-3150” supplied by Daicel. A powder coating composition for use according to the invention may be free of added colouring agents, but usually contains one or more such agents (pigments or dyes). Examples of pigments which can be used are inorganic pigments such as titanium dioxide, red and yellow iron oxides, chrome pigments and carbon black and organic pigments such as, for example, phthalocyanine, azo, anthraquinone, thioindigo, isodibenzanthrone, triphendioxane, and quinacridone pigments, vat dye pigments, and lakes of acid, basic, and mordant dyestuffs. Dyes can be used instead of or as well as pigments.

The composition of the invention may also include one or more extenders or fillers, which may be used inter alia to assist opacity, whilst minimising costs, or more generally as a diluent.

The composition of the invention may also include one or more performance additives, for example, a flow-promoting agent, a plasticiser, a stabiliser, e.g. against UV degradation, or an anti-gassing agent, such as benzoin, or two or more such additives may be used.

If so desired, one or more fluidity-assisting additives may be incorporated into the powder coating composition by dry-blending, for example, those disclosed in WO 94/11446, and especially the preferred additive combination disclosed in that reference, comprising aluminium oxide and aluminium hydroxide, preferably in proportions in the range of from 30:70 to 70:30. The amount of fluidity-assisting additive(s) incorporated by dry blending may be in the range of from, for example, 0.05 or 0.1 to 5% by weight, based on the total weight of the composition without the additive(s).

The present invention also pertains to substrates provided with a layer of a primer containing an electroheat-susceptible material and a layer of a powder coating composition. For specific embodiments of, for example, the nature of the substrate, the nature of the primer and the powder coating composition, etc., reference is made to what has been stated above.

In the following a number of specific embodiments of the present invention will be described. It should be noted that they are by no means intended to limit the invention in any way.

In one embodiment of the present invention, a plastic substrate is coated with a primer containing an electroheat-susceptible material in combination with a resin. The electroheat-susceptible material comprises 30-90 wt. % of the total of electroheat-susceptible material and resin. The resin is a solid powder coating resin as described above, which is dispersed in an aqueous primer. The primer is applied via a conventional application process for liquid paint. The primer layer is allowed to dry. Then, a powder coating composition is applied onto the substrate, e.g., via an electrostatic powder coating composition process. The coated substrate is treated with intermittent bursts of microwave radiation to allow curing of the powder coating composition.

In a variation of the above embodiment, the plastic substrate coated with the primer is heated to a temperature sufficient to soften the substrate surface. The temperature is sufficiently high to allow the electroheat-susceptible material to become embedded in the substrate surface. The heating also results in the curing of the resin in the primer, which helps to fix the electroheat-susceptible material to the substrate. After curing of the primer, the substrate surface is treated to remove loose material and the powder coating composition is applied and cured as described above.

In another embodiment of the present invention, an MDF substrate is coated with a primer containing an electroheat-susceptible material in combination with a resin. The electroheat-susceptible material comprises 10-40 wt. % of the total of electroheat-susceptible material and resin. The resin is a solid powder coating resin as described above, which is dispersed in an aqueous primer. The primer is applied via a conventional application process for liquid paint. The primer layer is allowed to dry. To ensure that a sufficient amount of electroheat-susceptible material is applied, more than one primer layer may be applied. Upon drying of the primer layer(s), the substrate is treated to remove surface irregularities, e.g., by sanding. Then, a powder coating composition is applied onto the substrate, e.g., via an electrostatic powder coating composition process. The coated substrate is treated with intermittent bursts of microwave radiation to allow curing of the powder coating composition.

In a further embodiment of the present invention, a mould is treated with a solid primer composition containing an electroheat-susceptible material in combination with a resin. The electroheat-susceptible material comprises 10-40 wt. % of the total of electroheat-susceptible material and resin. The resin is selected to be compatible with the resin that will make up the substrate. The primer is added to the mould in a conventional manner, e.g., via an electrostatic spray gun where the primer is in the form of a powder, or via a wet paint spray gun where the primer is in liquid form, or by a method as disclosed in EP-A 1 486 311. The latter method uses a carrier gas—e.g. nitrogen or carbon dioxide—at a pressure of, e.g., 3-100, more preferably 20-60 bar, and injects the primer in about 1-5 seconds.

The mould is heated to ensure sufficient curing of the resin to ensure adherence of the primer to the mould surface during addition of the liquid substrate resin. The liquid substrate resin is added to the mould, and the mould is heated to cure the substrate resin. Then, the substrate provided with a surface layer comprising an electroheat-susceptible material is released from the mould. The electroheat-susceptible material is embedded in the substrate surface. A powder coating composition is applied onto the substrate, e.g., via an electrostatic powder coating composition process. The coated substrate is treated with intermittent bursts of microwave radiation to allow curing of the powder coating composition.

### EXAMPLES

### Example 1

### Coating of Polypropylene Panel

### Primer Composition A was a Slurry of Electroheat-Susceptible Material Dispersed in Water

| | |
|---|---|
| carbon black electroheat-susceptible material | 5 grams |
| wetting agent (Dynwet 800) | 3 grams |
| dispersant (Byk 190) | 3 grams |
| water | 89 gram |

Primer composition A described above was sprayed using a hand-held compressed air sprayer to give an even coverage of primer on a polypropylene panel (dimensions 15 cm×10 cm×3 mm H×W×D). The primer was allowed to dry at room temperature. The substrate was then held in front of an infrared heating lamp for 3 seconds, which was sufficient to melt the surface of the polypropylene panel and allow the carbon black electroheat susceptible particles to become embedded in the substrate. During the heating the substrate bulk remained at a temperature below its distortion temperature. The panel was allowed to cool and then powder coated with a commercially available heat-curable epoxyphenolic powder coating composition using a standard powder coating corona spray gun. The coating was an even laydown of powder covering the areas that had been primer coated.

The panel was then placed in a standard 800 W domestic microwave oven and heated in 5-second bursts of full powder for 10 minutes microwave “on” time, 20 minutes total time. During this time, the underside surface of the panel reached a temperature of 90° C. whilst the topcoat surface temperature of the panel was measured to be a maximum of 130° C. Temperature measurement was performed by stopping the microwave heating, opening the door of the microwave oven, and measuring the sample temperatures with a thermal imaging camera. The powder coating composition melted, fused, and cured as evidenced by DSC (Differential Scanning Calorimetry) analysis, the powder coating composition had been fully cured. The coating was smooth and even across the panel with a high gloss and no discolouration.

### Example 2

### Coating of Polypropylene Panel—2

Primer composition A described above was sprayed using a hand-held compressed air sprayer to give an even coverage of primer on a polypropylene panel (dimensions 15 cm×10 cm x3 mm H×WxD). The primer was allowed to dry at room temperature.

The panel was then placed in a microwave cavity, such that the primer coating on the panel directly faced the waveguide directing the microwaves from their source. The panel's position was such that at the panel surface the microwave heating energy was at a maximum. 150 W of microwave power was directed at the panel for a duration of 1-2 seconds. The heating time was sufficient to allow the carbon black electroheat susceptible particles to become embedded in the substrate whilst the bulk of the substrate remained at a temperature of less than 40° C.

The panel was then powder coated with a commercially available heat-curable epoxyphenolic powder coating composition and cured in the manner described in Example 1. As evidenced by DSC (Differential Scanning Calorimetry) analysis, the powder coating composition had been fully cured. The coating was smooth and even across the panel.

### Example 3

### Coating of an ABS Panel

Primer B was a Slurry of Powder Coating Mixed with Electroheat-Susceptible Material with the Following Composition

| | | |
|---|---|---|
| carbon black pigment | 4 | g |
| polyester powder slurry | 20 | g |
| wetting agent (Dynwet 800) | 2.4 | g |
| water | 71.2 | g |

The formulation of the powder slurry contained in this primer is given below:

| | | |
|---|---|---|
| polyester resin | 56.8 | gram |
| carbon black electroheat-susceptible material | 37.5 | gram |
| curing agent (primid) | 2 | gram |
| catalyst (Irganox) | 0.2 | gram |
| flow control agent (benzoin) | 0.4 | gram |
| flow aid (Acronal low molecular weight acrylic) | 1.6 | grams |
| filler barytes (barium sulphate) | 2 | gram |

Primer composition B was sprayed onto an ABS panel (15 cm×10 cm×3 mm) using a hand-held compressed air spray gun. The primer was allowed to dry at room temperature. The substrate was then held in front of an infrared heating lamp for 3 seconds, which was sufficient to melt the surface of the polypropylene panel and allow the carbon black electroheat susceptible particles to become embedded in the substrate. During the heating the substrate bulk remained at a temperature below its distortion temperature. The panel was allowed to cool and then powder coated using an epoxy polyester hybrid powder coating. The coating was an even laydown of powder covering the areas that had been primer coated.

The panel was then placed in a standard 800 W domestic microwave oven and heated in 5-second bursts of full powder for 15 minutes microwave “on” time, 30 minutes total time. During this time, the underside surface of the panel reached a temperature of 90° C., whilst the topcoat surface temperature of the panel was measured to be a maximum of 130 C. Temperature measurement was performed by stopping the microwave heating, opening the door of the microwave oven, and measuring the sample temperatures with a thermal imaging camera. The powder coating composition melted, fused, and cured to give a smooth even coating with good flow and appearance.

### Example 4

### Coating of MDF Panel

A piece of MDF board (dimensions 15 cm×10 cm×15 mm H×W×D) was spray-coated with primer formulation B to give an even coverage of primer. The composition of primer B is in the table above.

The primer was dried under an infrared heating lamp. The panel was then placed in a standard 800 W domestic microwave oven and heated using microwave power to a temperature not exceeding 140° C. and held at that temperature for 2 minutes microwave contact time. This treatment was carried out to remove some of the surface moisture from the board that would otherwise disrupt the surface appearance of the final cured powder coating.

The board was then coated with a commercially available heat-curable epoxyphenolic powder coating composition using a standard powder coating corona spray gun. The panel was then placed in a standard 800 W domestic microwave oven and heated to a maximum surface temperature of 110° C. and kept at that temperature for 20 minutes to fully cure the powder coating. The powder coating was smooth and blemish-free on all surfaces, and the edges were coated with a smooth coating showing no porosity.

### Example 5

### Primer Application Via In-Mould Coating Process

A test mould was prepared by applying powder primer formulation C to the mould interior using a corona spray gun. The composition of primer formulation C is given below.

### Primer C

| | | |
|---|---|---|
| polyester resin | 83 | wt. % |
| organic peroxide | 2 | wt. % |
| carbon black electroheat-susceptible material | 11.5 | wt. % |
| zinc stearate as mould release agent | 2 | wt. % |
| flow additives | 1.5 | wt. % |

The coating was cured at 149° C. for three minutes. The mould was filled with Sheet Moulding Compound (SMC). Heat and pressure were applied to press the SMC into a flat sheet with a surface coating of primer formulation C. The sheet was removed from the mould.

Due to the presence of the primer, the surface conductivity of the substrate was sufficiently high to allow electrostatic coating of the substrate. The substrate was thus coated with a commercially available heat-curable epoxyphenolic powder coating composition using a standard powder coating corona spray gun. The panel was then placed in a standard 800 W domestic microwave oven for 30 minutes total time and heated in short bursts of microwave power ensuring that the temperature of the SMC did not exceed its deformation temperature. The final coating was smooth with full cure, showing no visible signs of surface disruptions due to escaping volatiles.

1. A process for coating a substrate comprising the steps of
a. providing a substrate the outer layer of which comprises an electroheat-susceptible material,
b. applying a powder coating composition onto the substrate, and
c. curing the powder coating composition using electroheat radiation.

2. The process according to claim 1 wherein the powder coating composition is applied onto the outer layer of the substrate which comprises the electroheat-susceptible material.

3. The process according to claim 1 wherein the substrate is provided with an outer layer which comprises the electroheat-susceptible material by contacting the substrate with a primer comprising the an electroheat-susceptible material.

4. The process according to claim 3 wherein the contacting with the primer is performed by coating the substrate with the primer containing the electroheat-susceptible material.

5. The process according to claim 3 wherein the contacting with the primer is performed by coating the inside of a mould with a primer layer, filling the mould with a curable resin that will form the substrate, curing the resin, and releasing the substrate the outer layer of which comprises the electroheat-susceptible material from the mould.

6. The process according to claim 3 wherein the primer further comprises a resin.

7. The process according to claim 6 wherein the primer contains 10-90 wt. % of the electroheat-susceptible material and 90-10 wt. % of the resin, both calculated on the total of the electroheat-susceptible material and the resin.

8. The process according to claim 6 wherein the resin is a curable resin which is cured before application of the powder coating composition.

9. The process according to claim 6 wherein the amount of the electroheat-susceptible material present on the substrate is between 0.5 gram/m² and 100 gram/m².

10. The process according to claim 1 wherein the electroheat-susceptible material is embedded in the substrate surface.

11. The process according to claim 1, wherein the electroheat-susceptible material is a microwave-susceptible material and the curing is effected using microwave radiation.

12. The process according to claim 1 wherein the electroheat-susceptible material is a radio frequency-susceptible material and the curing is effected using radio frequency radiation.

13. The process according to claim 3 wherein the primer is a liquid.

14. The process according to claim 3 wherein the primer is a powder.

15. The process according to claim 1 wherein the powder coating composition is in the form of a dry powder.

16. The process according to claim 1 wherein the powder coating composition is a powder coating slurry.

17. A substrate obtained by process according to claim 1.

18. The process according to claim 2 wherein the substrate is provided with an outer layer which comprises the electroheat-susceptible material by contacting the substrate with a primer comprising the electroheat-susceptible material.

19. The process according to claim 5 wherein the primer further comprises a resin.

20. The process according to claim 6 wherein the amount of the electroheat-susceptible material present on the substrate is between 1 gram/m² and 10 gram/m².
